(19) United States
(12) Patent Application Publication
(10) Pub. No.: US 2025/0389837 A1
(43) Pub. Date: Dec. 25, 2025

(54) METHOD AND APPARATUS FOR THROUGH-THE-WAL DEEP RADAR-BASED HUMAN ACTIVITY RECOGNITION

(71) Applicant: Abu Dhabi University, Abu Dhabi (AE)

(72) Inventors: Jawad Yousaf, Abu Dhabi (AE); Satanai Yakoub, Abu Dhabi (AE); Sara Karkanawi, Abu Dhabi (AE); Taimur Hassan, Abu Dhabi (AE); Mohammed Ghazel, Abu Dhabi (AE)

(73) Assignee: Abu Dhabi University, Abu Dhabi (AE)

(21) Appl. No.: 18/972,667

(22) Filed: Dec. 6, 2024

Related U.S. Application Data
(60) Provisional application No. 63/663,147, filed on Jun. 23, 2024.

(51) Int. Cl. G01S 13/56; G01S 13/62

(52) U.S. Cl. CPC G01S 13/56; G01S 13/62

(57) ABSTRACT

A method, includes receiving, by a computing device, electronic information about an area. The method includes determining, by the computing device, whether the area is occupied by a person. The area is located behind a wall and the wall is between the computing device and the area.

### BACKGROUND

Ultra-wideband radar (UWB) technology has become a popular choice for the detection and recognition of human activities through obstacles such as walls. UWB radar signals are capable of penetrating the thick obstacles and provide unique electromagnetic signatures of objects behind them based on the characteristics of reflected backscattered high frequency signals. These characteristics make them a promising candidate for various applications such as security and surveillance, search and rescue operations, indoor positioning, law enforcement, industrial, and medical domains

Radars are detection devices that emit an electromagnetic wave to recognize the characteristics of a target based on the reflected signals. Returning signals received by the transceivers consist of noise and target components. Different radar topologies differ in their ability to identify and isolate such components based on the radar's characteristics. UWB radars have been reputably utilized for their wide bandwidth. The technology is distinguished from traditional radars for its capability in detecting targets at an extended range and under harsh environmental conditions. In embodiments, UWB radars fall under the X-band region where radars have a wider bandwidth.

The broad bandwidth in UWB radars is advantageous due to its resilience to multipath fading. The signals transmitted by traditional radar systems are prone to environmental noises. In contrast, because of the signals transmitted in the wideband region, UWB radar signals are less susceptible to such occurrence which increases their robustness in both indoor and outdoor surroundings. However, there is currently no compact lightweight, one-dimensional convolutional neural network (1D-CNN) based UWB radar system that can be used in conjunction with other systems to determine the type of activity being conducted by the persons.

### BRIEF DESCRIPTION OF DRAWINGS

FIG. 1 is an example graphical diagram;

FIG. 2 is an example schematic diagram;

FIG. 3 is an example schematic diagram;

FIG. 4 is an example graphical diagram;

FIG. 5 is an example graphical diagram;

FIG. 6 is an example process diagram;

FIG. 7 is an example graphical diagram;

FIG. 8 is an example graphical diagram;

FIG. 9 is an example graphical diagram;

FIG. 10 is an example schematic diagram;

FIGS. 11 and 12 are example tables;

FIG. 13 is an example graphical diagram;

FIG. 14 is an example graphical diagram;

FIG. 15 is an example graphical diagram;

FIG. 16 is an example table;

FIG. 17 is an example graphical diagram;

FIG. 18 is an example graphical diagram;

FIG. 19 is an example graphical diagram;

FIG. 20 is an example schematic diagram of a hardware device;

FIGS. 21, 22, and 23 are example graphical diagrams;

FIG. 24 is a diagram of a network environment; and

FIG. 25 is a diagram of an example computing device.

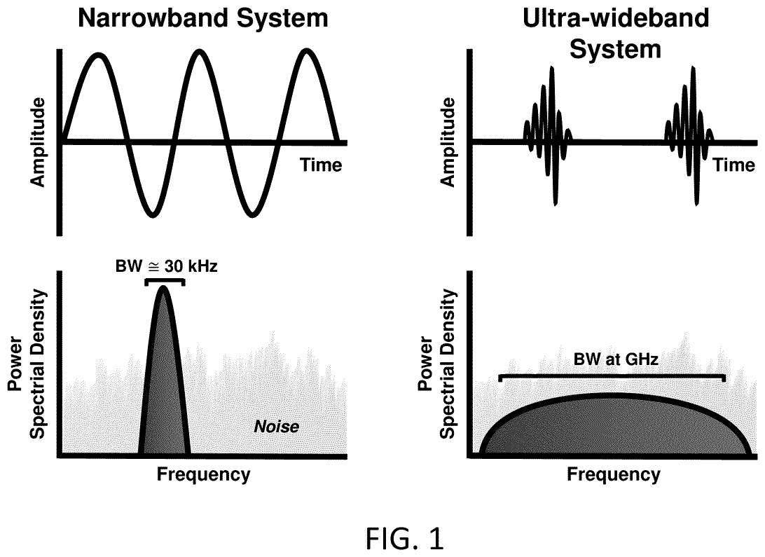

### DETAILED DESCRIPTION OF PREFERRED EMBODIMENTS

The following detailed description refers to the accompanying drawings. The same reference numbers in different drawings may identify the same or similar elements.

Systems, devices, and/or methods described herein may allow for utilizing the capabilities of a UWB radar with a combination of various intelligent deep learning methodologies. In embodiments, the systems, devices, and/or methods described herein include four main working blocks. In embodiments, the systems, devices, and/or methods described herein allow to determine whether an area (behind a wall) is not occupied, or if a person is standing, moving away, or moving towards a device described herein. In embodiments, detection of a physical entity (person, animal, etc.) is based on analysis of captured backscattered ultra-wideband radar signal with a developed lightweight one-dimensional conventional neural network (1D-CNN) model. In embodiments, the dataset used to train a model is a time domain signal and can consist of 15,000 samples. In embodiments, the optimized trained 1D-CNN model achieved a testing accuracy of 100.00% and a training accuracy of 99.82% with a mean average precision (mAP) of 100%. In embodiments, the model can be tested real-time based on unseen data (e.g., new samples for CNN model), yielding a testing result of more than 80%. In embodiments, users have the ability to capture the reference data, monitor room activity, and halt monitoring whenever they want using the systems, methods, and/or devices described herein. In embodiments, users can view the data captured in real-time and as a heatmap. In embodiments, systems, methods, and/or devices can be used for the recognition of human activity in various domains of law enforcement, security and surveillance, and search and rescue operations.

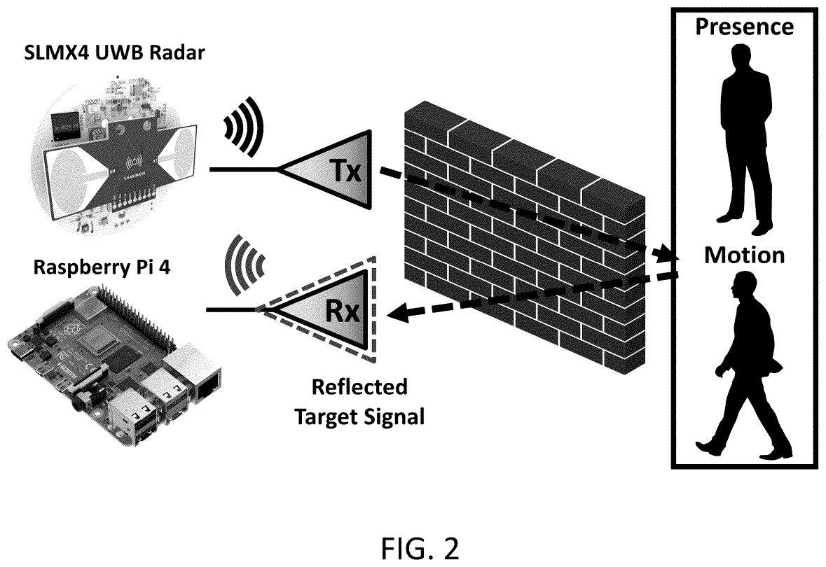

In embodiments, the systems, devices, and/or methods described herein provide for an accessible, lightweight, and sustainable handheld UWB device for Through-the-Wall (TTW) detection and prediction of human movement. In embodiments, through the extraction of features from target's returned echo signal, the portable UWB device can scan the area of a room and establish human presence as shown in FIG. 2. In the event of a moving target, the system is meant to distinguish between different movements taking place. In embodiments, the back-scattered RF signatures received by an UWB radar enables data processing via an artificially intelligent deep learning system for the robust imaging, detection, and classification of identified targets.

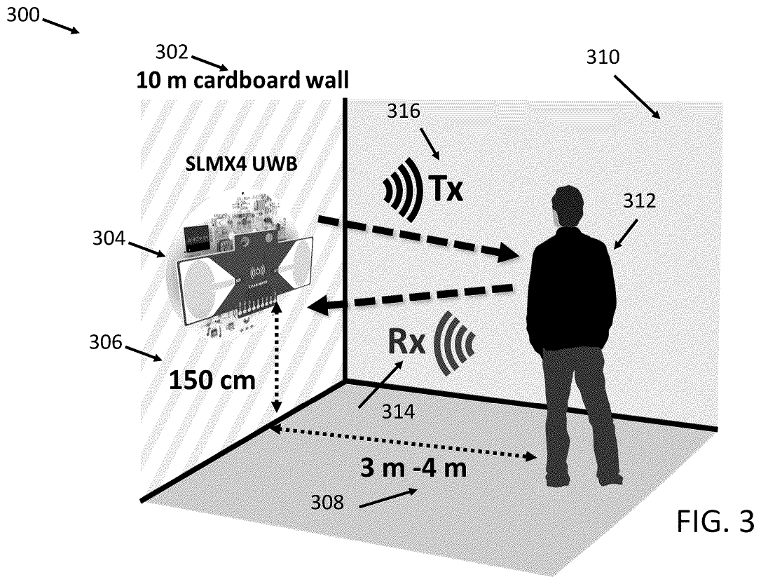

In embodiments, the recording of the distinct RF signatures for various human motion in an empty area (e.g., a room) is achieved by installing an SLMX4 IR-UWB radar 304 on the wall 302 as shown in FIG. 3. In a non-limiting example, the data collection process takes place in a clutter free 10×6 meter empty room 310. In embodiments, this selection minimizes the interference of noise and ensures that most of the reflected signals are a result of the target 312 occupying the room. In embodiments, the 304 radar is positioned behind the wall at a height 306 of 150 cm above the ground. The placement of device 304 allows for a greater line-of-sight (LOS) for the detection of targets at an extended range. In embodiments, the 304 features a sampling rate of 23.328 GHz that allows to capture back scattered radar signals 314 in the frequency range of 7.25-10.2 GHz.

In embodiments, the dataset of 15000 time-domain signals for four different classes empty, standing, and moving towards and moving away is recorded using the setup shown in FIG. 3. In embodiments, empty is defined as being determined to be a room with no person 312 present. The standing class is attained for a stationary person 312 standing at a certain distance (e.g., 3 meters 308) from the wall. Alternatively, the moving class is classified as a person 312 walking back and forth at a constant speed from and to the wall from 0 to 4 meters shown by 318. In embodiments, each class was collected for a total of 5,000 samples, resulting in a total dataset of 15,000 samples. Each signal contains 1,560 time-samples.

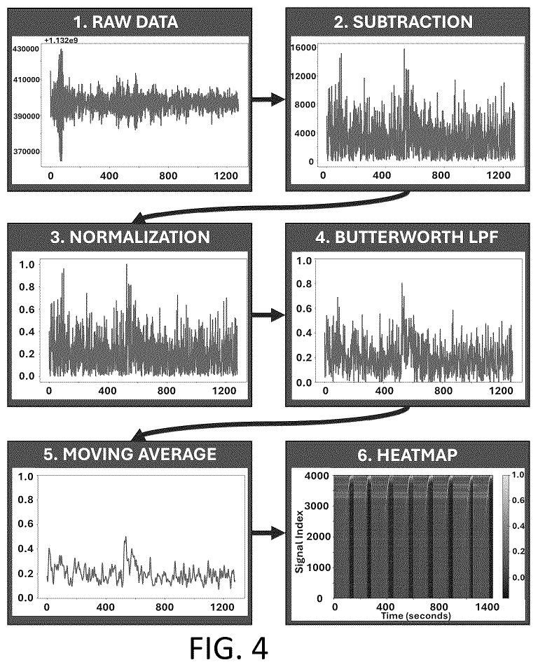

Due to the inherently noisy nature of the signals generated by the radar sensor, in embodiments, a multi-step pre-processing method precedes the forwarding signal to the machine learning classifier. In embodiments, the steps for pre-processing on obtained radar signals are depicted in FIG. 4.

In embodiments, a common feature in all captured data is the high energy taking place at the start of raw data signal as shown in FIG. 4, part 1 (“raw data’). In embodiments, this is based on the high energy emitted from the direct path-Tx to Rx antenna. In embodiments, the amount of energy in the direct path is caused due to the neighboring Tx and Rx antennas. Therefore, its occurrence is unavoidable, however, additive measurements can be used for its removal. In embodiments, to accomplish this, the signal is truncated to 150 samples (in a non-limiting example) without risking the loss of vital information representative of target motion. Similarly, high energy is slightly exhibited at the end of sample and is removed too. As a result, the final signal spans from samples 150 to 1430, resulting in a signal length of 1,280 samples per signa.

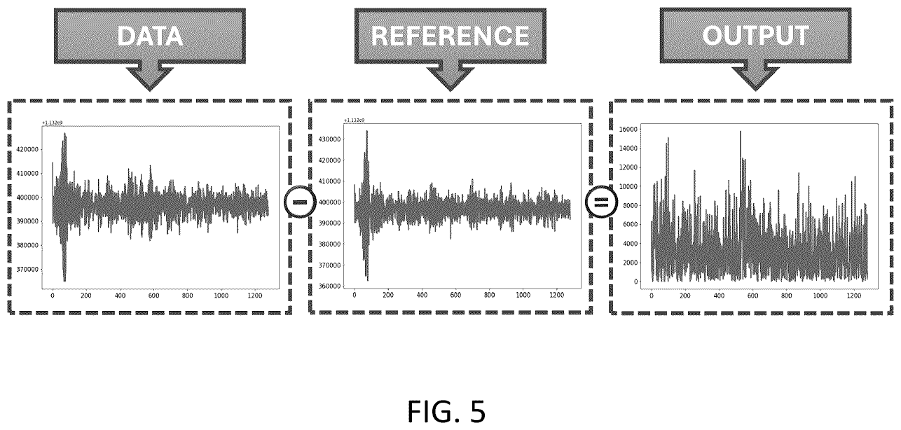

In embodiments, the use of background subtraction is effective in mitigating the presence of large noisy artifacts. In embodiments, the success of this method depends on acquiring a foreground reference of the empty room, enabling the computation of the difference between the occupied room and reference signature. As a result, similar patterns exhibited in both instances are removed while prominently accentuating peaks attributed to target movement. FIG. 5 shows the implemented background subtraction technique using Equation (1). Where x(i) represents all signals retrieved during the monitoring of the room. In embodiments, the empty room reference signal in FIG. 5 is denoted as y(n) and its subtraction from x(i) produces the shown output X(i). Equation (1) is as follows:

$$X ( i ) = \vert x ( i ) - y ( n ) \vert \qquad ( 1 )$$

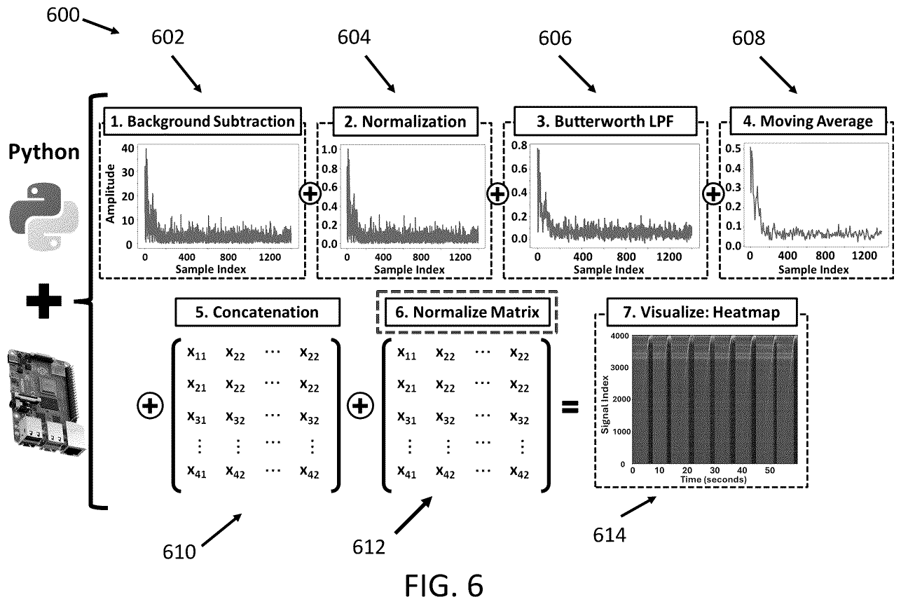

In embodiments, interpreting the numerical outputs of the signals is relatively complex when working with substantial variations in peaks of X(i). In embodiments, FIG. 6 describes different processes of signal processing. In embodiments, process 602 provides the background subtracted signal. In embodiments, the impact of scaling is minimized using 604 by normalizing the X(i) using Max-Min linear normalization as depicted in Equation 2. In embodiments, the normalization enhanced the system ability to analytically determine distinctive patterns between differing classes. Equation (2) is as follows:

$${X ( i )}_{norm} = \frac{X ( i ) - min ( X ( i ) )}{max ( X ( i ) ) - min ( X ( i ) )} \qquad ( 2 )$$

In embodiments, the normalized signal from process 604 is passed through a 4th order Infinite Impulse Response (IIR) Butterworth low-pass filter (LPF) (process 606) to minimize the impact of high frequency contents in it. In embodiments, the filtered output is represented as X(i)′ norm and is fed to process 608. In embodiments, the used IIR filter exhibits an improved frequency response with a reduced number of coefficients that make the design computationally efficient as shown by equation (3):

$$H ( z ) = \frac{{b}_{0} + {b}_{1} {z}^{- 1} + {b}_{2} {z}^{- 2} + ⋯ + {b}_{N} {z}^{- N}}{{a}_{0} + {a}_{1} {z}^{- 1} + {a}_{2} {z}^{- 2} + ⋯ + {a}_{N} {z}^{- N}} \qquad ( 3 )$$

In embodiments, the subsequent refinement step in FIG. 6 includes the convolution of the filtered signal with second order moving average filter of process 608 as shown in FIG. 6, graph 5, and equation (3). Falling under the category of finite impulse response (FIR) filters, implementing the averaging filter can result in a stable shown output in FIG. 6, graph 5 that ultimately refines noisy fluctuations for signals in the time domain as equation (4):

$${y [ n ]}^{′} = ( {X}_{norm}^{′} * g ) [ n ] = {\sum }_{k = - ∞}^{∞} {X}_{norm}^{′} [ k ] \cdot g [ n - k ] \qquad ( 4 )$$

In embodiments, the moving averaging process entails the convolution of the filtered signal with a Gaussian kernel of size M=12 and a standard deviation of σ=3. In embodiments, the kernel, represented by a matrix based on the set parameters, convolves with the filtered signal Xnorm as demonstrated in Equation 3. In embodiments, process 608 finalizes the preprocessing stage of the raw data before feeding it to the 610. In embodiments, all signals of their respective class are concatenated into a matrix Z[n], normalized using 612, and fed into the proposed machine learning network as input for further human activity classification. In embodiments, FIG. 6 describes complete signal pre-processing for feature extraction.

In embodiments, FIG. 6 uses a data file x, a reference file y, radar center frequency F_{c}; Radar sampling frequency Fₛ; Window size M; and Standard deviation σ, In embodiments, process 600 provides a normalized matrix of processed signals [symbol] Z[n] [symbol] _norm; Time values t. In embodiments, prior to step 602, process 600 reads data signals from x, reads reference signals from y, initializes empty list Z[n]. Furthermore, for for i=1, 2, . . . , x, truncate x(i) and y(15).

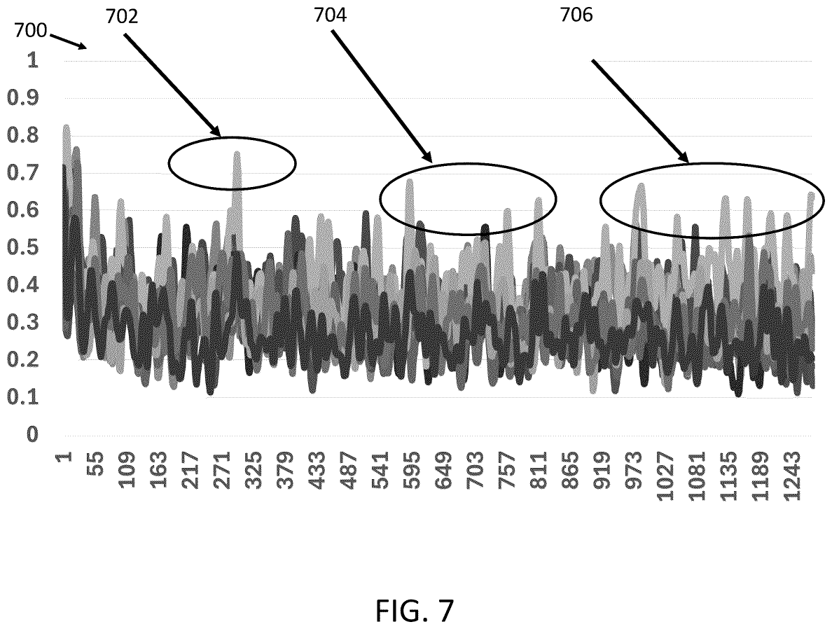

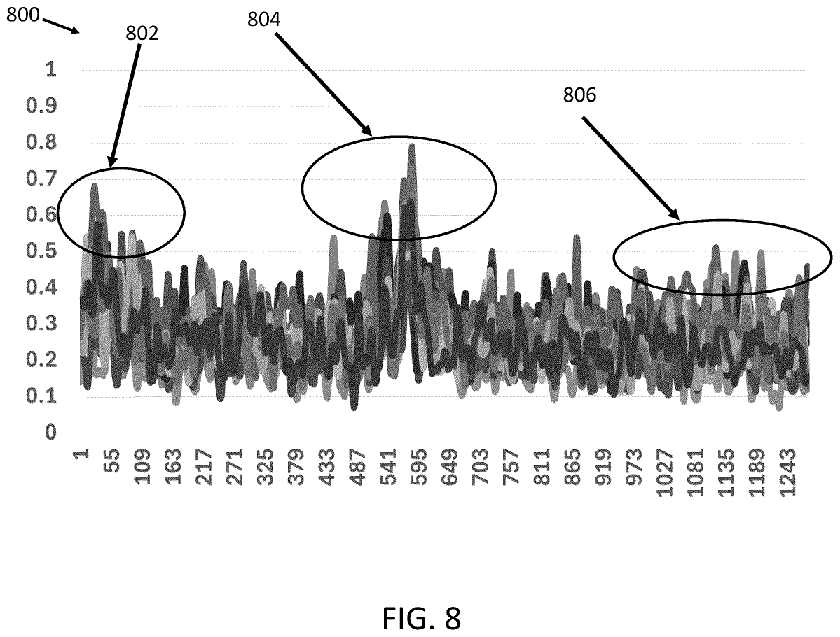

FIGS. 7, 8, and 9 describe the processed time domain signals for the three different classes of human activity dataset. The waveforms show that the signals of empty class contain peaks (702, 704, and 706) which are more random in nature, typically normalized amplitude ranging from 0.2 to 0.45. Alternatively, the standing class consists of peaks (802, 804, and 806) that stand out due to their high amplitude in comparison to the smaller peaks experienced throughout the signal. Large peaks (802, and 804) are representative of the target position and typically fall at an approximated amplitude of 0.6 and 0.85 for this case. In embodiments, the large peaks are clustered at one specific area (804) that indicates that the target is standing in one area for all recorded iterations.

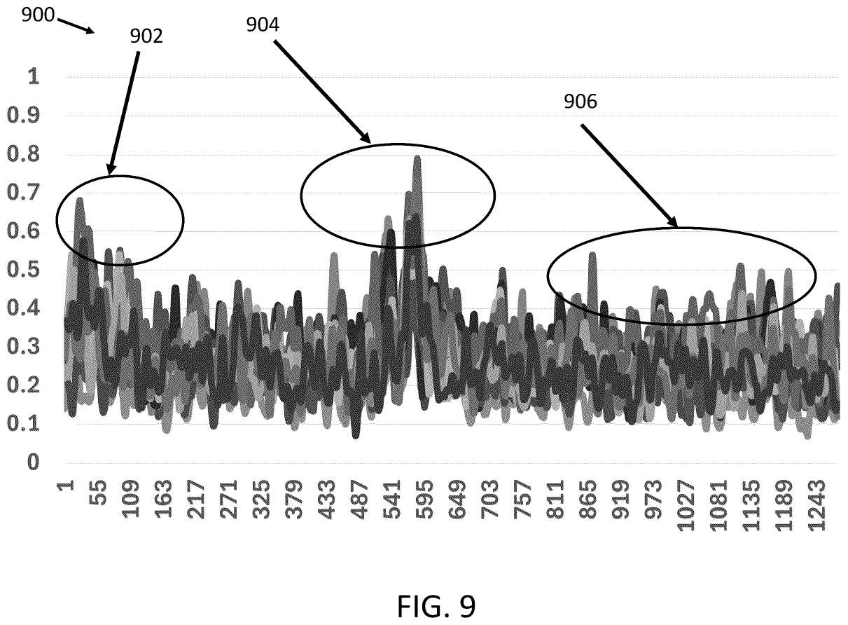

However, this differs from the moving class which experiences large peaks at different ranges of 902, 904, and 906. For example, when a person is moving back and forth, the peaks at a greater amplitude reflect the instances where the target is at a closer range to the radar. Such peaks of 902 and 904 range from an amplitude of 0.5 to 0.85. Another feature of the moving class is the minimal peaks trailing 908 after the large peaks of 902 and 904. Compared to other classes, the moving class exhibits a lower amplitude of peaks 902 and 906 ranging between 0.5 and 0.25 as depicted in FIG. 9. In embodiments, the accurate prediction of the human activity class is done by the implemented lightweight one-dimensional convolutional neural networks (CNNs) based on Z(n).

In embodiments, progress with CNNs taking a prominent role at its forefront. Designed based on the human visual cortex, CNNs excel in tasks related to computer vision and image recognition

In embodiments, a CNN is a feed-forward neural network, capable of extracting features from data within its convolution layers. One of the many advantages of CNN is its local connections, meaning that each neuron is now linked to only a limited set of neurons in the preceding layer, rather than connecting to all of them. Accordingly, this proves effective in minimizing parameters and speeding up the convergence process. Another advantage is weight sharing which is when a group of connections can utilize identical weights, thereby reducing the overall number of parameters even more. Lastly, CNNs often uses down sampling through its pooling layers in order to reduce the dimensions of the data. This enhances computational efficiency since the amount of data is reduced yet the critical information is still retained.

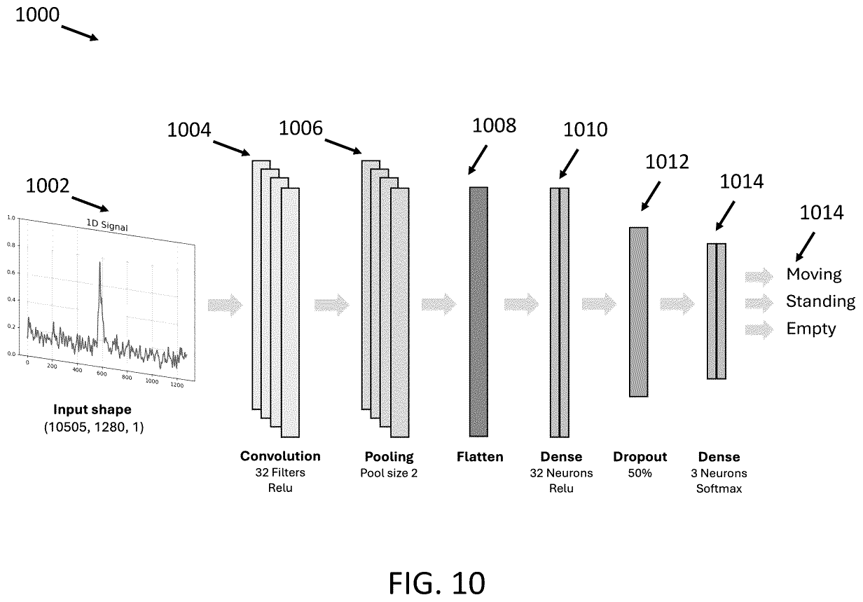

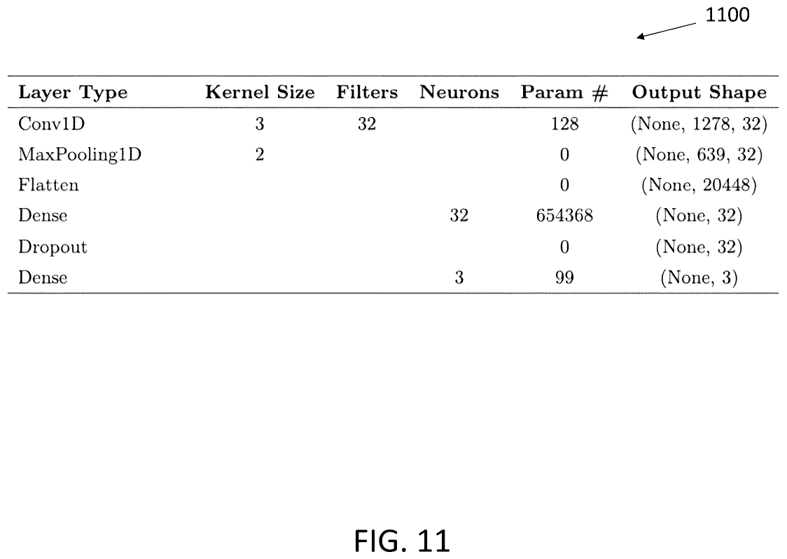

In embodiments, the implemented CNN model can be a 1D-CNN that takes pre-processed time domain 1002 signals (Z(n)) as input. In embodiments, the machine learning model consists of six layers that can be seen in FIG. 10 with architecture details in table 1100 shown in FIG. 11. In embodiments, the first 1004 convolutional layer applies 32 filters with a kernel size of 3 to the input signals with ReLU (Rectified Linear Unit) as activation function. In embodiments, the input data X=Z[n] of this layer is expected to have the shape (for example, “i”, number of features, time stamp) is convolved with different filters (W) and added biases (b) to produce the output Z1 using the below equation.

$${Z}_{1} [ i , t , c ] = {\sum }_{j = 0}^{2} {\sum }_{d = 0}^{0} {\sum }_{f = 0}^{31} X [ i , t + j , d ] \times {W}_{1} [ j , c , d , f ] + {b}_{1} [ c ]$$

In embodiments, the 1006 pooling layer applies max pooling with a pool size of 2 to reduce the dimensionality of the extracted feature maps by the convolution layers to retain only the most important high frequency features.

In embodiments, 1008 layer in the architecture flattens the multidimensional output of the previous layer into a 1D vector (Output=Input.reshape(−1)) preparing it for the subsequent dense layer of 1010. In embodiments, the last dense layer in the implemented FIG. 10 architecture is a fully connected layer with 32 neurons and ReLU activation function.

In embodiments, the added 1012 dropout layer randomly drops 50% (p as dropout rate) of the neurons during training to prevent overfitting with produced output of D.

In embodiments, the last 1014 layer of the designed lightweight ID-CNN is a fully connected layer with 3 neurons representing the number of classes to be predicted. The probability output of this layer corresponding to the respective class is computed as Z3 as in below equation:

$${Z}_{3} [ i , j ] = {\sum }_{k = 0}^{31} D [ i , k ] \times {W}_{3} [ k , j ] + {b}_{3} [ j ]$$

In embodiments, the hyperparameter optimization of the designed schematic 1000 is performed for the real-time deployment of the trained model. Different experimental models of 1200 were executed to determine the impact of various modal parameters such as epochs 1201, batch size 1202, training size 1203, dataset size 1204, input signal truncation 1205, cross validation, optimizer 1206, loss function 1207, and dataset type 1208 on the classification performance of 1209 and 1210. The analysis is conducted for two types of datasets: Dataset 1 of four classes (empty, standing, moving away, and moving towards) and Dataset 2 of three classes (empty, standing, moving). In Dataset 2, ‘moving class combines the samples of both moving away and towards movements.

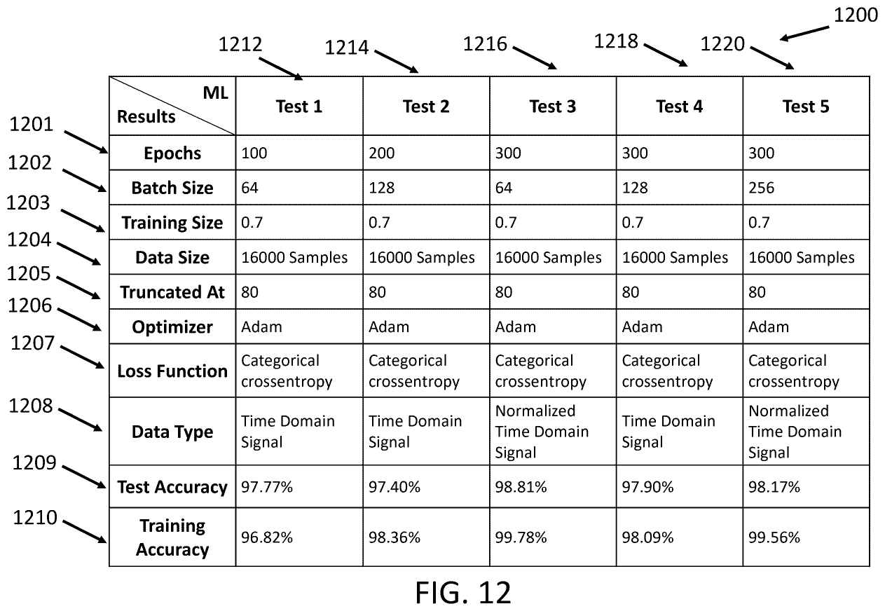

In embodiments, table 1200 as shown in FIG. 12 describes table 1200 which shows the results of different experimented models on Dataset 2. Dataset 2 contains 4000 samples of each class to ensure class balancing. In embodiments, the test-set method is applied as cross validation techniques for all the analysis with 70% of data as training data 1203. For Test 1, 1212 and Test 2 1214, dataset of truncated time domain signals without normalization is used as model input which produces maximum testing accuracy of 97.77% in the case of 1212.

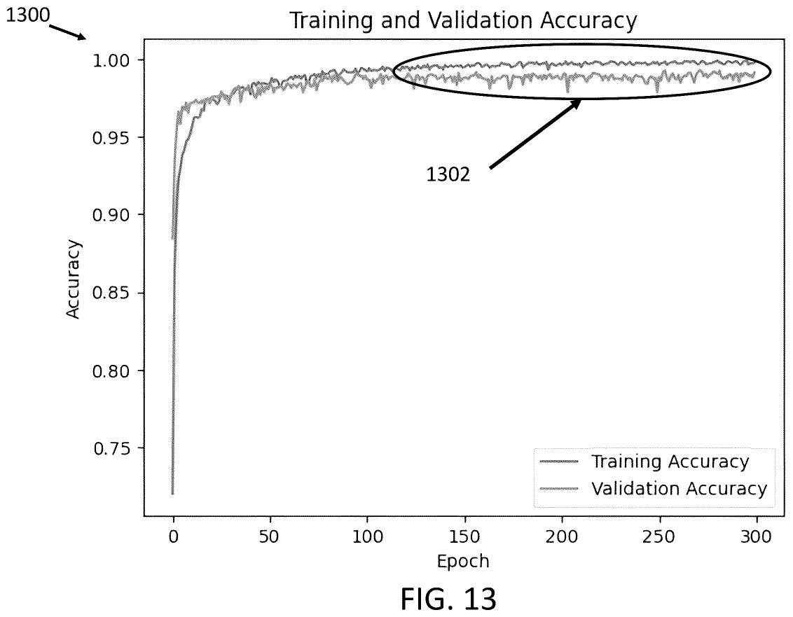

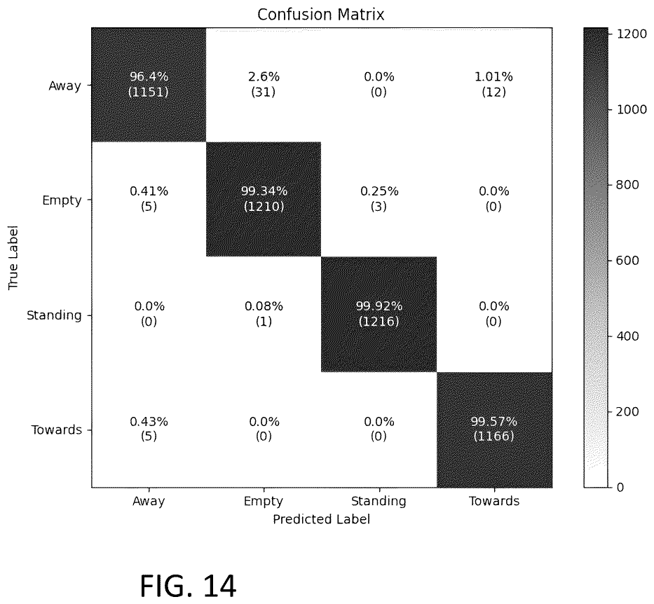

In embodiments, the increase in epochs 1201 (entire passing of the training data to the CNN model) did not produce significant improvement in performance as testing accuracy 1209 increased to 97.40% for the case of Test 2 (1214). In embodiments, 1201 is fixed at 300 while the 1202 and 1208 are varied for the cases of Tests 3-5 (1216, 1218, and 1220 respectively). In embodiments, the maximum achieved training and test accuracies for 1216, for example, are 99.78% and 98.81% which shows good performance of the trained test model 1216. FIGS. 13 and 14 describe the variations in the performance in terms of accuracies and confusion matrix (such as, for example, 1216). Although good results in terms of class predictions are observed in FIG. 14, an overfitting 1302 can be noted in FIG. 13 results which can increase the false results. Similar overfitting is noticed for other experiments of table 1200 in FIG. 12.

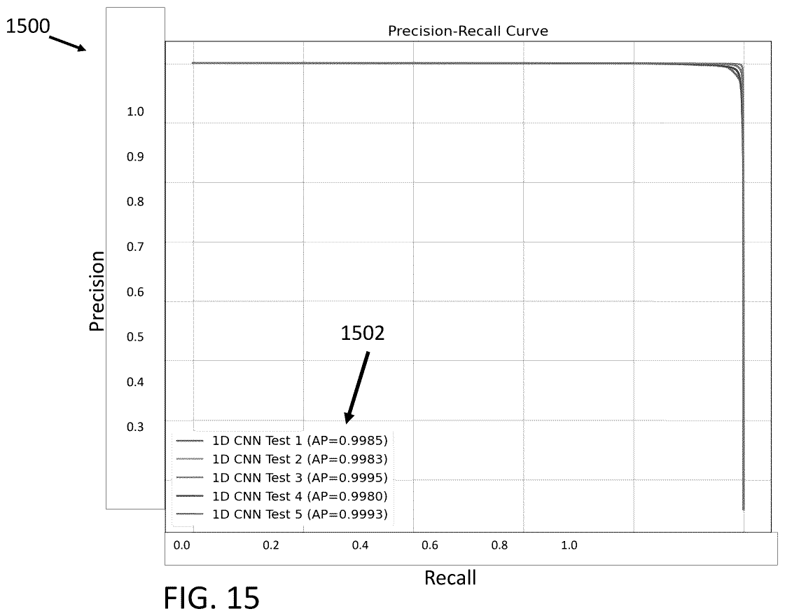

In embodiments, the characterization of a classifier in terms of various thresholds can be done using precision-recall curves. The precision-recall curve for table 1200 is depicted in FIG. 15. The mean average precision (mAP) metric results 1502 for each classifier are shown against each experiment of table 1200. The combination of both precision and recall in mAP provides an objective and comprehensive evaluation of the classifier performance against varying thresholds. All the models showed exemplary outcomes with more than 99% mAP. Test three and four yielded the highest mAP of 0.9995 and 0.9980 respectively.

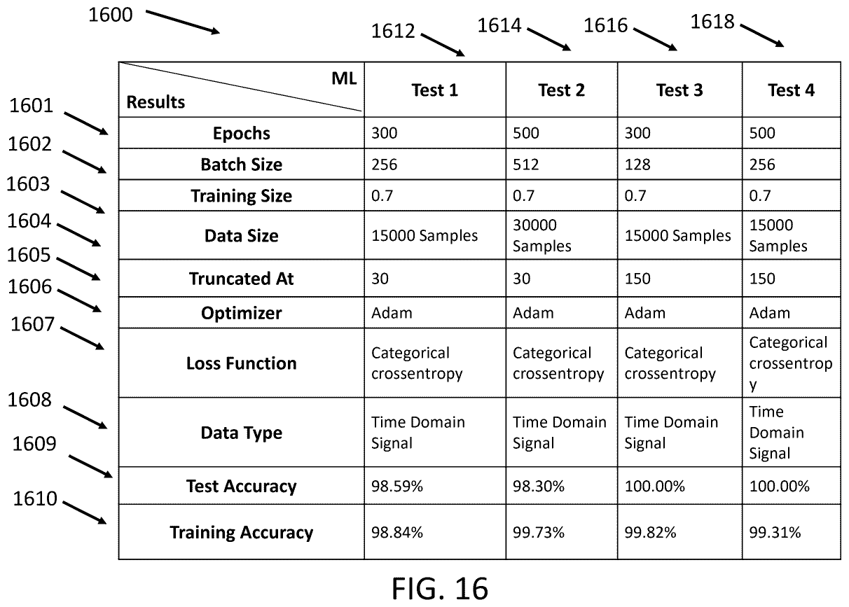

To address the overfitting issue 1302, the classification is simplified by merging the classes ‘Moving Away’ and ‘Moving Towards’ into a single class named ‘Moving’, reducing the total number of classes to three instead of four. In embodiments, this dataset is termed as Dataset 2 with a total size of 15000 samples. FIG. 16 describes table 1600 that shows the various models 1612, 1614, 1616, and 1618 explored, with model 1616 being the optimal choice for both training and real-time testing on Dataset 2.

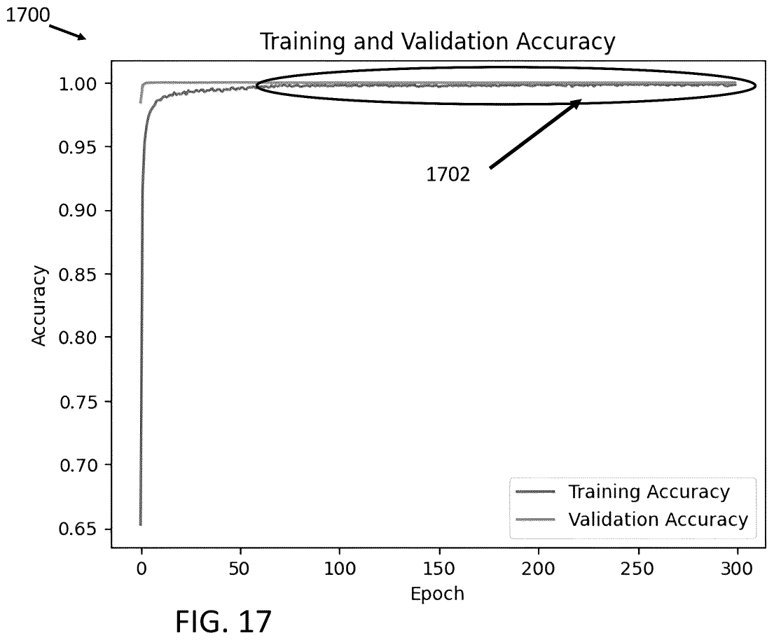

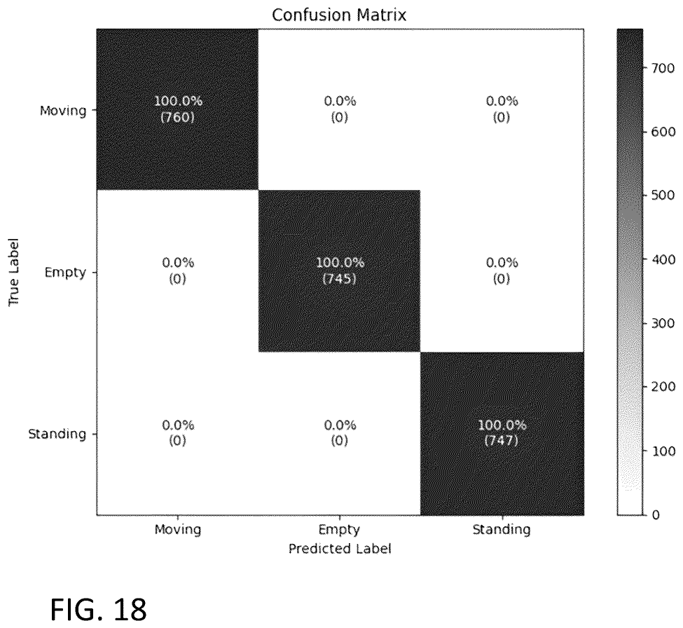

Test one implemented with 300 epochs 1601, a batch size of 256 1602, and 15000 samples 1604 yielded the lowest results. The model in test 1616 had promising results with 300 epochs and a batch size of 128, which indicates that the model was efficient in accurately predicting our different classes. FIGS. 17 and 18 are the results obtained from the 1616 trained model with a test accuracy 1609 of 100.00% and training accuracy 1610 of 99.82%. The superior performance of the trained optimal ID classifier model can be observed in both FIGS. 17 and 18 with no overfitting 1702.

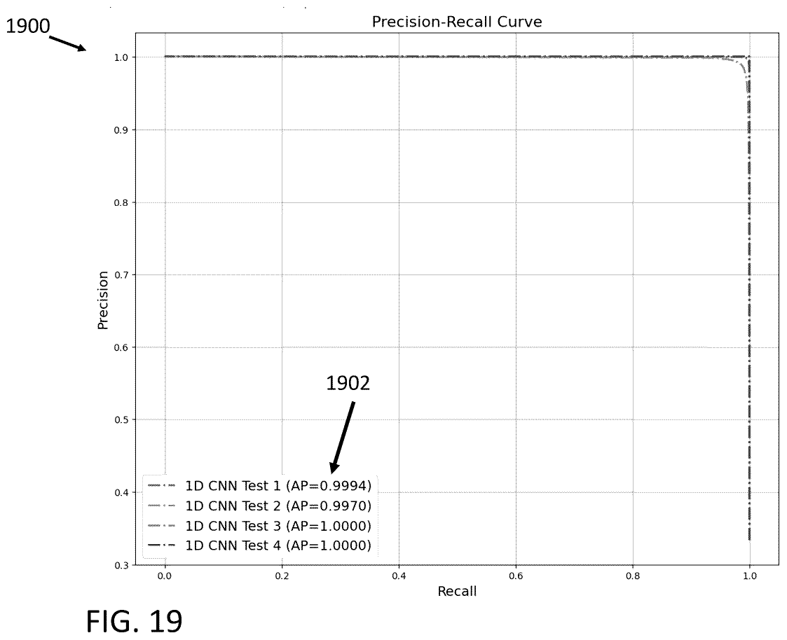

With regard to the precision-recall curve shown in FIG. 19 for Dataset 2, tests three and four exhibited a mean average precision (mAP) 1902 of 100%, whereas test two recorded the mAP of 99.7%. In embodiments, this comparison reflects that Dataset 2 performance did not vary significantly with the variations in the analyzed hyperparameters of table 1600. The optimal 1616 model is further deployed on the Raspberry Pi for real time product development and testing.

In embodiments, the systems, methods, and/or devices with its SLMX4 IR-UWB Radar technology 304, was able to penetrate a 10 cm thick cardboard wall 302 achieving an accuracy of 100.00% in testing and 99.82% in training. In embodiments, the machine learning algorithm (CNN), trained with a dataset of 15,000 samples, ensured robust detection of human presence and motion outperforming systems with simpler machine learning models. In embodiments, a GUI can capture 50 continuous samples until a button is pressed to halt. Then, the samples will be processed in approximately 30 seconds and the predicted class is displayed for the user.

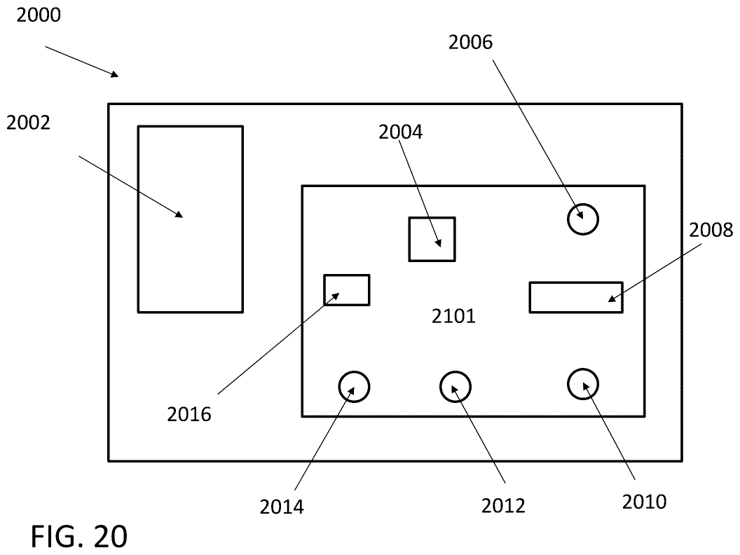

In embodiments, a compact handheld device is designed that integrates the UWB radar sensor, processing unit (Raspberry Pi), touch screen display unit (LCD), and other components shown in the schematic design of hardware device 2000 in FIG. 20. As shown in FIG. 20, hardware device 2000 is shown with circuit board 2001, power bank 2002, heat sink 2004, LCD connection 2006, radar connection 2008, touch screen connection 2010, LCD to RPi connection 2012, power connection 2014, and RPi connection 2016.

In embodiments, the display of the handheld device was determined by prioritizing compactness and portability. After careful evaluation, the Waveshare 5 inch capacitive LCD touch screen may be used. However, other sized LCD screens may be used. Its low power consumption allows for compatibility with the selected processing unit. The details of the internal layout of integrated components are given in FIG. 20.

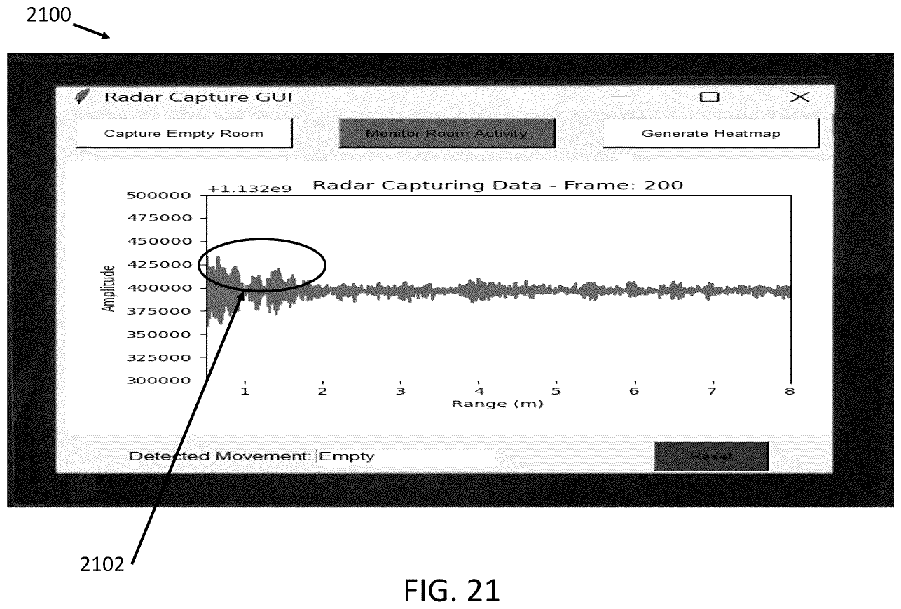

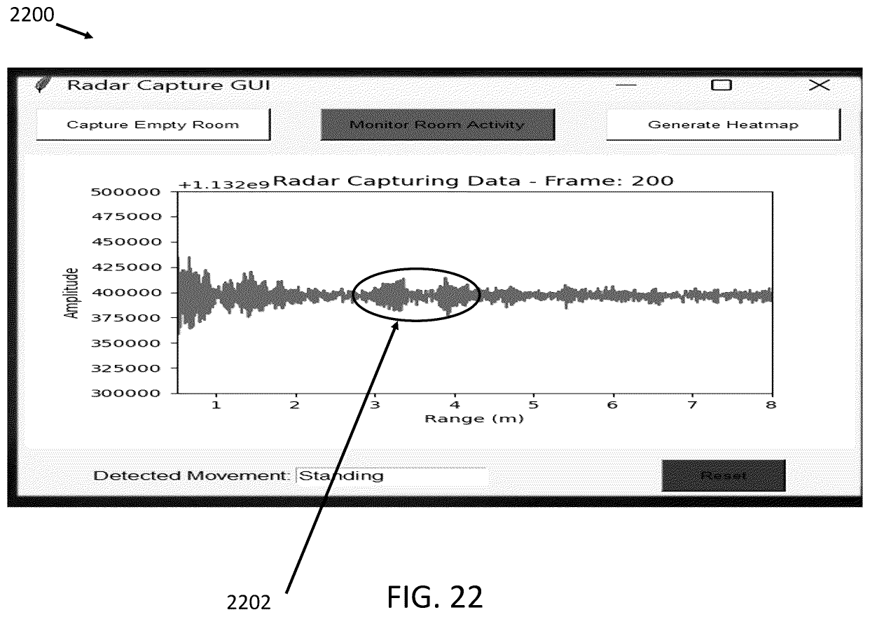

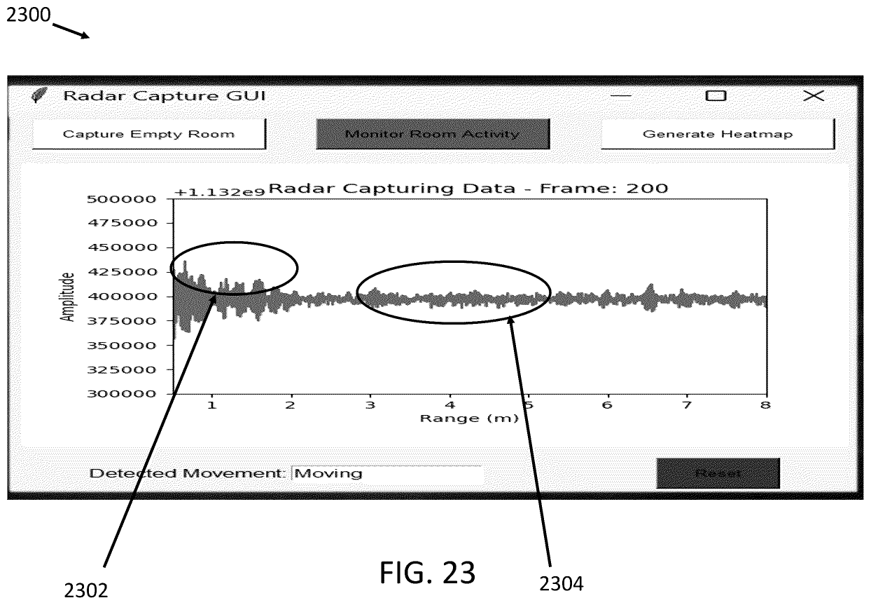

In embodiments, real time testing, using the developed system in FIG. 20 is performed to estimate the system's confidence in detecting the human movements or lack of movement behind the wall. In embodiments, the optimized trained ID-CNN model is exported to Raspberry Pi. The captured raw data from the radar sensor is fed to Raspberry Pi for further processing and classification by the CNN model in real time. The real time product testing produces good performance with a mean average accuracy of more than 80% for each case of human activity recognition. The instances correctly predicted in real-time for each class have been presented in FIGS. 21 (2102), 22 (2202), and 23 (2302, and 2304) for each type of human activity.

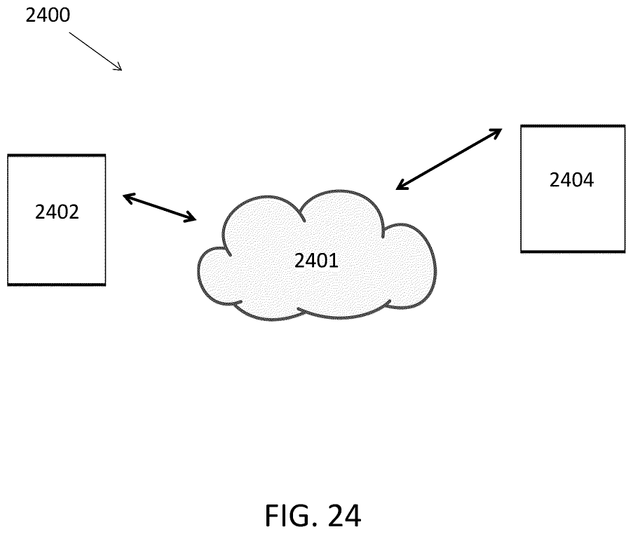

FIG. 24 is a diagram of example environment 2400 in which systems, devices, and/or methods described herein may be implemented. FIG. 24 shows network 2401, user device 2402, user device 2404, and antenna 2206.

Network 2401 may include a local area network (LAN), wide area network (WAN), a metropolitan network (MAN), a telephone network (e.g., the Public Switched Telephone Network (PSTN)), a Wireless Local Area Networking (WLAN), a WiFi, a hotspot, a Light fidelity (LiFi), a Worldwide Interoperability for Microware Access (WiMax), an ad hoc network, an intranet, the Internet, a satellite network, a GPS network, a fiber optic-based network, and/or combination of these or other types of networks. Additionally, or alternatively, network 2200 may include a cellular network, a public land mobile network (PLMN), a second generation (2G) network, a third generation (3G) network, a fourth generation (4G) network, a fifth generation (5G) network, and/or another network.

In embodiments, network 2401 may allow for devices describe any of the described figures to electronically communicate (e.g., using emails, electronic signals, URL links, web links, electronic bits, fiber optic signals, wireless signals, wired signals, etc.) with each other so as to send and receive various types of electronic communications.

User device 2402 and/or 2404 may include any computation or communications device that is capable of communicating with a network (e.g., network 2401). For example, user device 2402 and/or user device 2404 may include a radiotelephone, a personal communications system (PCS) terminal (e.g., that may combine a cellular radiotelephone with data processing and data communications capabilities), a personal digital assistant (PDA) (e.g., that can include a radiotelephone, a pager, Internet/intranet access, etc.), a smart phone, a desktop computer, a laptop computer, a tablet computer, a camera, a personal gaming system, a television, a set top box, a digital video recorder (DVR), a digital audio recorder (DUR), a digital watch, a digital glass, or another type of computation or communications device.

User device 2402 and/or 2404 may receive and/or display content. The content may include objects, data, images, audio, video, text, files, and/or links to files accessible via one or more networks. Content may include a media stream, which may refer to a stream of content that includes video content (e.g., a video stream), audio content (e.g., an audio stream), and/or textual content (e.g., a textual stream). In embodiments, an electronic application may use an electronic graphical user interface to display content and/or information via user device 2402 and/or 2404. User device 2402 and/or 2404 may have a touch screen and/or a keyboard that allows a user to electronically interact with an electronic application. In embodiments, a user may swipe, press, or touch user device 2402 and/or 2404 in such a manner that one or more electronic actions will be initiated by user device 2402 and/or 2404 via an electronic application.

User device 2102 and/or 2104 may include a variety of applications, such as, for example, an e-mail application, a telephone application, a camera application, a video application, a multi-media application, a music player application, a visual voice mail application, a contacts application, a data organizer application, a calendar application, an instant messaging application, a texting application, a web browsing application, a blogging application, and/or other types of applications (e.g., a word processing application, a spreadsheet application, etc.).

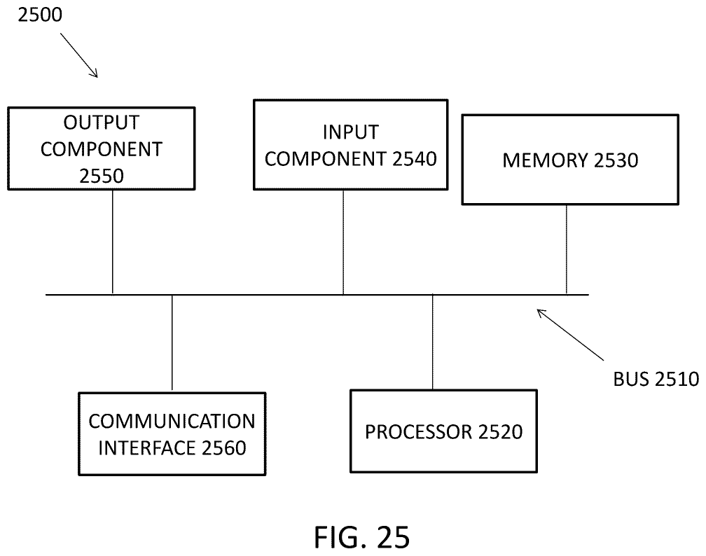

FIG. 25 is a diagram of example components of a device 2500. Device 2500 may correspond to user device 2402, user device 2404, and device 2000. Alternatively, or additionally, user device 2402, user device 2404, and device 2000 may include one or more devices 2500 and/or one or more components of device 2500.

As shown in FIG. 25, device 2500 may include a bus 2510, a processor 2520, a memory 2530, an input component 2540, an output component 2550, and a communications interface 2560. In other implementations, device 2500 may contain fewer components, additional components, different components, or differently arranged components than depicted in FIG. 25. Additionally, or alternatively, one or more components of device 2500 may perform one or more tasks described as being performed by one or more other components of device 2500.

Bus 2510 may include a path that permits communications among the components of device 2500. Processor 2520 may include one or more processors, microprocessors, or processing logic (e.g., a field programmable gate array (FPGA) or an application specific integrated circuit (ASIC)) that interprets and executes instructions. Memory 2530 may include any type of dynamic storage device that stores information and instructions, for execution by processor 2520, and/or any type of non-volatile storage device that stores information for use by processor 2520. Input component 2540 may include a mechanism that permits a user to input information to device 2500, such as a keyboard, a keypad, a button, a switch, voice command, etc. Output component 2550 may include a mechanism that outputs information to the user, such as a display, a speaker, one or more light emitting diodes (LEDs), etc.

Communications interface 2560 may include any transceiver-like mechanism that enables device 2500 to communicate with other devices and/or systems. For example, communications interface 2560 may include an Ethernet interface, an optical interface, a coaxial interface, a wireless interface, or the like.

In another implementation, communications interface 2560 may include, for example, a transmitter that may convert baseband signals from processor 2520 to radio frequency (RF) signals and/or a receiver that may convert RF signals to baseband signals. Alternatively, communications interface 2560 may include a transceiver to perform functions of both a transmitter and a receiver of wireless communications (e.g., radio frequency, infrared, visual optics, etc.), wired communications (e.g., conductive wire, twisted pair cable, coaxial cable, transmission line, fiber optic cable, waveguide, etc.), or a combination of wireless and wired communications.

Communications interface 2560 may connect to an antenna assembly (not shown in FIG. 25) for transmission and/or reception of the RF signals. The antenna assembly may include one or more antennas to transmit and/or receive RF signals over the air. The antenna assembly may, for example, receive RF signals from communications interface 2560 and transmit the RF signals over the air, and receive RF signals over the air and provide the RF signals to communications interface 2560. In one implementation, for example, communications interface 2560 may communicate with network 2401.

As will be described in detail below, device 2500 may perform certain operations. Device 2500 may perform these operations in response to processor 2520 executing software instructions (e.g., computer program(s)) contained in a computer-readable medium, such as memory 2530, a secondary storage device (e.g., hard disk, CD-ROM, etc.), or other forms of RAM or ROM. A computer-readable medium may be defined as a non-transitory memory device. A memory device may include space within a single physical memory device or spread across multiple physical memory devices. The software instructions may be read into memory 2530 from another computer-readable medium or from another device. The software instructions contained in memory 2530 may cause processor 2520 to perform processes described herein. Alternatively, hardwired circuitry may be used in place of or in combination with software instructions to implement processes described herein. Thus, implementations described herein are not limited to any specific combination of hardware circuitry and software.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

While various actions are described as selecting, displaying, transferring, sending, receiving, generating, notifying, and storing, it will be understood that these example actions are occurring within an electronic computing and/or electronic networking environment and may require one or more computing devices, as described in FIG. 25, to complete such actions. Furthermore, it will be understood that these various actions can be performed by using a touch screen on a computing device (e.g., touching an icon, swiping a bar or icon), using a keyboard, a mouse, or any other process for electronically selecting an option displayed on a display screen to electronically communicate with other computing devices as described in FIG. 24. Also, it will be understood that any of the various actions can result in any type of electronic information to be displayed in real-time and/or simultaneously on multiple user devices (e.g., similar to device 2000).

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a computing device, electronic information about an area;
determining, by the computing device, whether the area is occupied by a person,
wherein the area is located behind a wall and the wall is between the computing device and the area.

2. The method of claim 1, wherein the determining whether the area is occupied further comprises:
analyzing captured backscattered ultra-wideband radar signal.

3. The method of claim 1, further comprising:
determining, by a computing device, whether the area has another person that is moving in a particular direction, wherein the computing device distinguishes between the person and the other person.

4. The method of claim 1, wherein the computing device has a training accuracy of 99.82 for determining whether the area has the person.
